(19) United States
(12) Patent Application Publication
(10) Pub. No.: US 2011/0318614 A1
(43) Pub. Date: Dec. 29, 2011

(54) ELECTROLYTE, BATTERY USING SAME, AND METHOD OF USING SAME, AND METHOD FOR PRODUCING ELECTROLYTE

(75) Inventors: Kazumasa Takeshi, Kanagawa (JP); Hiroyuki Morioka, Kanagawa (JP)

(73) Assignee: SONY CORPORATION, Tokyo (JP)

(21) Appl. No.: 13/201,018

(22) PCT Filed: Feb. 8, 2010
(86) PCT No.: PCT/JP2010/051819

§ 371 Date: Aug. 11, 2011

(30) Foreign Application Priority Data
Feb. 20, 2009 (JP) 2009-037309

(51) Int. Cl. H01M 10/02; H01M 10/056; H01M 10/05; B82Y 30/00

(52) U.S. Cl. 429/50; 429/188; 429/341; 977/734; 977/742; 977/748

(57) ABSTRACT

In one example embodiment, an electrolyte has favorable ionic conductivity at low temperatures. In one example embodiment, a solid electrolyte is provided between a cathode and an anode. In one example embodiment, the electrolyte is formed of electrolyte salt such as a lithium salt, carbon cluster such as fullerene, and a liquid having polarity and dissociating the electrolyte salts into ions like organic solvents such as acetone and ionic liquids such as EMITFSI (1-ethyl-3-methyl imidazolium bis(trifluoromethanesulfonyl)imide).

### TECHNICAL FIELD

The present invention relates to an electrolyte containing an electrolyte salt, a battery using the same, and the method for using them, and the method for producing the electrolyte.

### BACKGROUND ART

In recent years, portable electronic devices such as a camera-integrated videotape recorder (VTR), mobile phones, and notebook personal computers have widely used, and it is strongly demanded to reduce the size and weight, and long-life operation in these devices. Therefore, a battery as a power source of the portable electronic devices, i.e. a secondary battery particularly having light weight and providing a high energy density has been developed. Specifically, a secondary battery utilizing insertion and extraction of lithium as an electrode reactant for charge and discharge reaction (i.e. lithium ion secondary battery) is extremely prospective, because such a secondary battery allows a higher energy density compared to a lead battery and a nickel cadmium battery.

As an electrolyte of the lithium ion secondary battery, a liquid electrolyte (electrolytic solution) in which a lithium salt as an electrolyte salt is dissolved in an ester carbonate solvent is widely used. However, in the battery using the electrolytic solution, the electrolytic solution may leak, and thereby the surrounding electronic parts may be destroyed. Therefore, use of a solid electrolyte instead of the electrolytic solution has been proposed.

The electrolytic solution used in the lithium ion battery may be gelated by methods such as addition of a polymer or a fumed silica and cross-linkage of a dissolved monomer, and thus it is supposed that the gel electrolyte has an improved adhesion to an electrode and an improved safety (prevention of short circuit and overcharging) and accordingly has an advantage of non-leakage (for example, see Non Patent Literature 1 described below).

The gel electrolyte typically includes, for example, (a) a combination of a cross-linkage or porous polymer, an electrolytic solution, and an alkali metal salt, and (b) a combination of a cross-linkage or porous polymer, an ionic liquid, and an alkali metal salt, and as a matrix, a polymer material is used.

The solid electrolyte includes an inorganic or an organic electrolyte. However, the inorganic electrolyte forms inappropriate interfaces with a cathode and an anode, and has low flexibility. Therefore, an organic solid electrolyte has received attention.

As the organic solid electrolyte used in the secondary battery, an electrolyte containing a polymer and an electrolyte salt is widely known. A solid electrolyte using polyether compounds including typically a polyethylene oxide as a polymer has been actively investigated.

Incidentally, as an electrolyte film having proton conductivity used for a fuel cell, a perfluoro sulfonic acid resin is widely used. In addition, a technique using carbon cluster such as fullerence and carbon nanotube having a proton dissociable group, and a technology using a polymer compound in which each carbon cluster having an ion dissociable functional group is linked to each other with a linking group in between have been known (for example, see Patent Literatures 1 and 2 described below). Additionally, for the above carbon cluster, a technique using the carbon cluster as a material of an anode active material and as an additive of an electrolytic solution in secondary batteries has been also considered (for example, see Patent Literatures 3 and 4 described below).

Additionally, a gel having carbon nanotube and an ionic liquid has been reported. (for example, see Patent Literature 5 and Non Patent Literature 2 described below).

Patent Literature 5 entitled “A gel composition having carbon nanotube and an ionic liquid and the method for producing the same” describes as following.

In the method for producing a gel composition having carbon nanotube and ionic liquid, the method includes a process of fragmenting carbon nanotube with shear force in the presence of an ionic liquid, and preferably a process of centrifuging the product resulted from the fragmenting process.

The invention according to Patent Literature 5 provides a specific technique allowing preparation of a material (composition) containing carbon nanotube with excellent workability by only physical manipulation. The technique has three indispensable elements, that is, 1) carbon nanotube, 2) an ionic liquid, and 3) a process of fragmenting the carbon nanotube and the ionic liquid by shear force, and thus the gel composition prepared by using the technique of Patent Literature 5 is not able to be obtained if any one of the three elements lacks.

On pulverizing 1 part by weight of a single-walled carbon nanotube (HiPco:Carbon Nanotechnologies, purity of 95% or more) and 200 parts by weight of an ionic liquid, 1-butyl-3-methyl imidazolium tetrafluoroborate (BMIBF₄) in an automatic mortar to grind the mixture at room temperature for 15 minutes, there was obtained a black paste product. This paste product was subjected to centrifugation (9,100 g, 3 hours), and thereby was separated a black gel composition containing the ionic liquid and having approximately 1% by weight of the carbon nanotube (HiPco), from a clear solution of the ionic liquid.

In the same manner, gel compositions were prepared by using other ionic liquids, i.e. 1-ethyl-3-methyl imidazolium tetrafluoroborate (EMIBF₄), 1-hexyl-3-methyl imidazolium tetrafluoroborate (HMIBF₄), 1-butyl-3-methyl imidazolium bis(trifluoromethylsulfonyl) imide (BMITf₂N), and 1-butyl-3-methyl imidazolium hexafluorophospate (BMIPF₆). When EMIBF4 and HMIBF₄ were used as an ionic liquid, in the same as BMIBF₄, there was obtained a gel composition containing approximately 1% by weight of the carbon nanotube (HiPco). When BMITf₂N and BMIPF₆ were used, a gel was further effectively formed, thus a gel composition containing approximately 0.5% by weight of the carbon nanotube (HiPco) was obtained.

For comparison, commonly used an organic solvent, i.e. dichlorobenzene, ethanol, or N,N-dimethylformamide (DMF), or as a precursor of the ionic liquid i.e. 1-methylimidazole was used in the place of the above described ionic liquid for pulverizing the resultant mixture with the carbon nanotube (HiPco) in an automatic mortar under a high shear force at room temperature for more than two hours in the same manner as Example 1. However, there was obtained no gel product.

Further, in place of the carbon nanotube (HiPco), graphite (1 to 2 μm, manufactured by Aldrich Co.), active charcoal, or C₆₀(purity: 99.9%, manufactured by TCI) was used as a carbonaceous material for the above pulverization under the same high shear force as Example 1. However, gel formation was not observed in any of carbonaceous materials.

Note that: Patent Literatures 6 to 11 described below describe respectively a molten salt polymer; Patent Literature 12 describes an ionic conductive polymer electrolyte with a polymer during binding a quaternary phosphonium salt in the molecule; and Patent Literature 13 describes a composite polymeric electrolyte composition produced by polymerizing a molten salt monomer, which has a quaternary ammonium salt structure and a polymerizable functional group, and a monomer composition, which includes a charge transfer ion source, in the presence of a polymer reinforcing material. Further, Non Patent Literature 2 describes gelation of a polymerizable ionic liquid.

### CITATION LIST

### Patent Literature

Patent Literature 1: Japanese Patent No. 3951225 (paragraph numbers 0015 to 0018)

Patent Literature 2: Japanese unexamined patent publication No. 2004-055562 (paragraph numbers 0023 to 0028)

Patent Literature 3: Japanese unexamined patent publication No. 2005-116327 (paragraph numbers 0004 to 0005)

Patent Literature 4: Japanese unexamined patent publication No. 2004-234949 (paragraph numbers 0006 to 0008)

Patent Literature 5: Japanese Patent No. 3676337 (paragraph numbers 0006, 0008, and 0026 to 0027)

Patent Literature 6: Japanese unexamined patent publication No. Hei10-838821 (paragraph numbers 0005 to 0008, and 0013 to 0016, Examples)

Patent Literature 7: Japanese unexamined patent publication No. Hei11-86632 (paragraph numbers 0004 to 0007, Examples)

Patent Literature 8: Japanese unexamined patent publication No. 2000-3620 (paragraph numbers 0006, and 0028 to 0032)

Patent Literature 9: Japanese unexamined patent publication No. 2000-11753 (paragraph numbers 0006 and 0017)

Patent Literature 10: WO2005-012599 (page 15, line 48 to page 16, line 2)

Patent Literature 11: Japanese unexamined patent publication No. 2006-049158 (paragraph number 0015)

Patent Literature 12: Japanese unexamined patent publication No. 2002-343133 (paragraph numbers 0014, and 0020 to 0021)

Patent Literature 13: WO2004-088671 (page 4, line 4 to page 5, line 33)

### Non Patent Literature

Non Patent Literature 1: Masaki Yoshio, Akiya Kozawa, “Lithium ion secondary batteries”, p112 and p113, 2004, NIKKAN KOGYO SHIMBUN, LTD., p112 “gel electrolyte separators”)

Non Patent Literature 2: T. Fukushima et al, “Molecular Ordering of Organic Molten Salts Triggered by Single-Walled Carbon Nanotubes”, SCIENCE VOL300, 2072 to 2074 (27 Jun. 2003) (page 2072, middle column, line 6 to right column, line 34, and page 2074, left column, line 1 to middle column, line 36)

### SUMMARY OF INVENTION

Existing typical gelatinous electrolytes include for example, (a) a combination of a cross-linkage or porous polymer, an electrolytic solution, and an alkali metal salt, (b) a combination of a cross-linkage or porous polymer, an ionic liquid, and an alkali metal salt, and the like, and a polymer material is used as a matrix. However, a polymer material lacks heat-resistance and chemical-resistance. Therefore, because of glass-transition temperature, the property of the electrolyte at low temperatures may reduce, and alternatively the glass-transition temperature of the polymer material may increase when an alkali metal salt is added. Therefore, there is need for molecular design in consideration of these possibilities.

The solid electrolyte containing the above polymer compound used for a secondary battery is adapted to be ionic conductive, as lithium ions dissociated in the polymer compound move in response to segmental motion of polymer chains. Therefore, at low temperatures, segmental motion may reduce and thereby the ionic conductivity of the solid electrolyte tends to significantly reduce. Accordingly, it has been difficult to maintain a favorable battery property in a wide temperature range.

Additionally, Patent Literature 5 and Non Patent Literature 2 describe that a gelatinous material is obtained by stirring carbon nanotube and an ionic liquid in a mortar, and in contrast, no gelatinous material is obtained by using fullerenes. In the past, a gelatinous electrolyte with an ionic liquid and fullerenes having high ionic conductivity in a low temperature range has not been known.

The present invention is provided to solve the above disadvantage, and thus the purpose is to provide an electrolyte having favorable ionic conductivity at low temperatures and a battery using the same, and a method of its use, and a method of producing the electrolyte.

Namely, the present invention relates to an electrolyte formed from a liquid mixture which includes an electrolyte salt containing at least one of an alkali metal salt and an alkali-earth metal salt (for example, LiTFSI in an embodiment described below), a carbon cluster (for example, fullerene in an embodiment described below), and a liquid compound having polarity and causing ion dissociation of the electrolyte salt (for example, acetone, EMITFSI in an embodiment described below).

Further, the present invention relates to a battery which has the above electrolyte, a cathode (for example, a cathode 14 in an embodiment described below), and an anode (for example, an anode 15 in an embodiment described below).

Furthermore, the present invention is a method for using the above battery in which the battery is used at a temperature of 100° C. or below.

Furthermore, the present invention relates to a method for producing an electrolyte, and the method has: a first step of preparing a liquid mixture by addition of an electrolyte salt containing at least one of an alkali metal salt and an alkali-earth metal salt (for example, LiTFSI in an embodiment described below) and a carbon cluster (for example, fullerene in an embodiment described below) to a liquid compound having polarity and causing dissociation of the electrolyte salt into ions (for example, acetone, EMITFSI in an embodiment described below); and a second step of desiccating the liquid mixture by vacuum heating.

According to the present invention, there is provided an electrolyte, and the electrolyte is formed of an electrolyte salt, a carbon cluster, and a liquid compound; has a structure in which the electrolyte salt is retained in a matrix (non-polymeric matrix) with carbon clusters because of containing the carbon cluster; has good heat-resistance and favorable ionic conductivity at low temperatures; has no glass-transition temperature as in a polymeric matrix and thereby has better properties compared to an electrolyte with the polymeric matrix ; and has favorable stability.

Further, according to the present invention, there is provided a battery capable of maintaining favorable battery properties as reduction of ionic conductivity at low temperatures in the electrolyte is prevented.

Further, according to the present invention, there is provided a battery capable of securing excellent electrical properties, in which decomposition/deterioration caused by temperature elevation and reduction of ionic conductivity never occur in an electrolyte.

Further, according to the present invention, there is provided a method for producing an electrolyte having stabilities such as heat-resistance and favorable ionic conductivity at low temperatures.

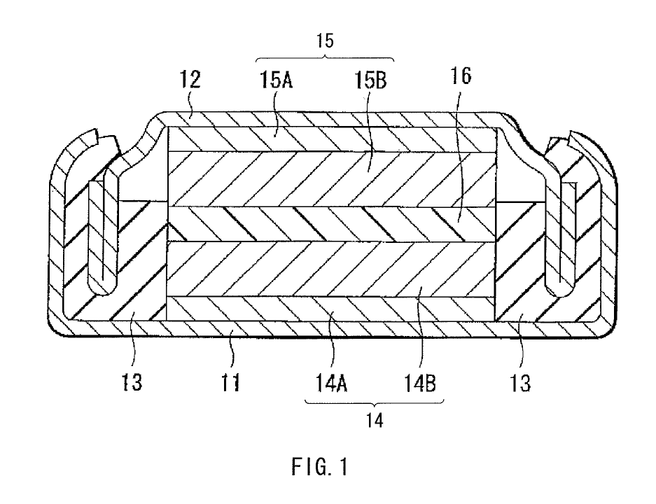

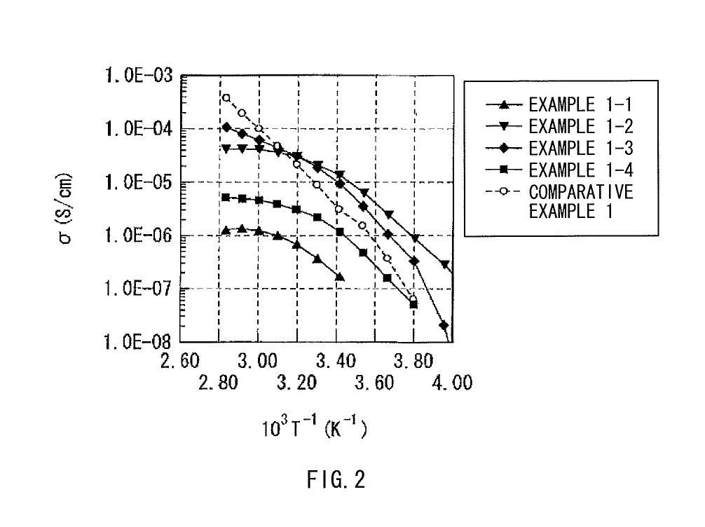

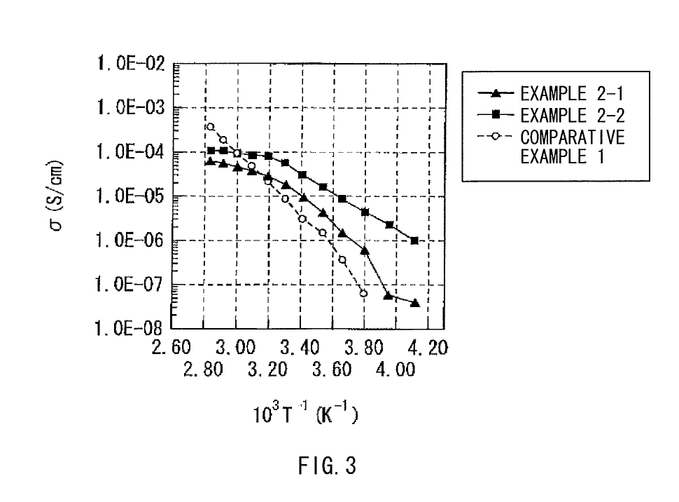

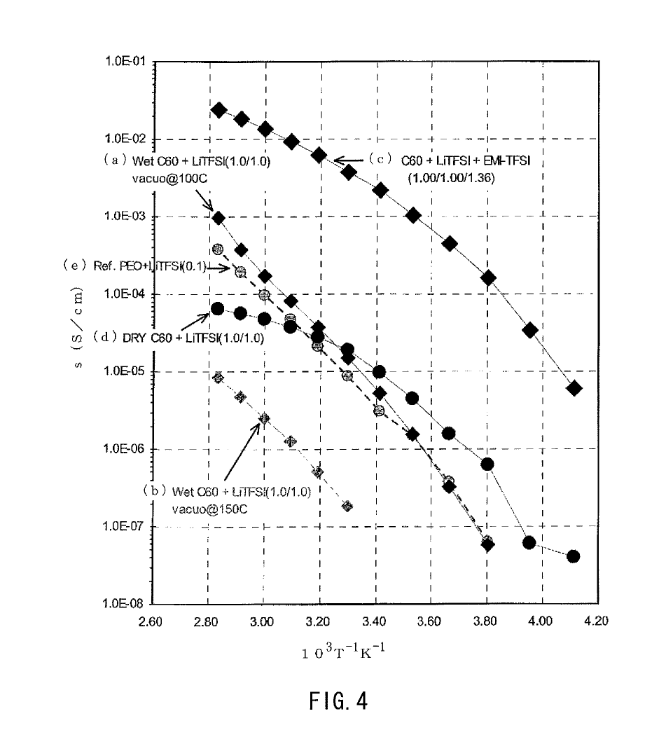

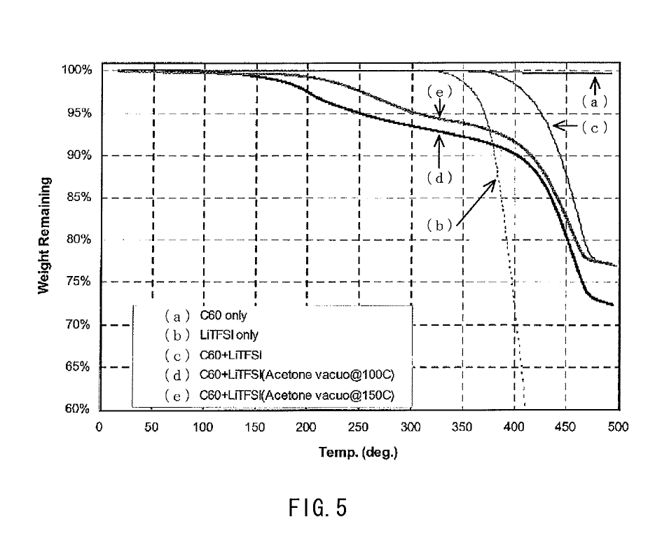

### BRIEF DESCRIPTION OF DRAWINGS

[FIG. 1] FIG. 1 is a cross sectional view illustrating a structure of a first battery according to an embodiment of the present invention.

[FIG. 2] FIG. 2 is a diagram illustrating temperature property of each ionic conductivity of electrolytes according to examples of the present invention.

[FIG. 3] FIG. 3 is a diagram illustrating a temperature property of ionic conductivity in electrolytes according to examples of the present invention.

[FIG. 4] FIG. 4 is a diagram illustrating a temperature property of ionic conductivity in electrolytes according to examples of the present invention.

[FIG. 5] FIG. 5 is a diagram illustrating TG curves of C₆₀, LiTFSI, and an electrolyte according to examples of the present invention.

### DESCRIPTION OF EMBODIMENTS

The electrolyte according to the present invention may have a structure in which an liquid compound is an organic solvent having any one of ether group, ester group, and carbonyl group. According to this structure, the stable electrolyte, which has favorable ionic conductivity at low temperatures; is not pyrolyzed approximately 130° C. or below; and has heat-resistance at approximately 130° C., may be achieved. Ether group is a divalent radical —O—, and C—O—C represents ether bond. Further, ester group is a divalent radical, —O—C(═O)—, and C—O—C(═O)—C represents ester bond. Further, carbonyl group is a divalent radical, —C(═O)—.

Further, the liquid compound may be composed of an ionic liquid. According to this structure, the electrolyte, in which ionic conductivity in a wide temperature range between low-temperature and high-temperature is better than an electrolyte using a polymeric matrix; and has favorable stabilities such as heat-resistance, may be achieved. Note that the ionic liquid refers to “ionic liquid” or a what is termed “ambient temperature molten salt”, and in the present invention, the ionic liquid refers to a salt composed of anion and cation and having a melting point of 100° C. or below.

Further, there may be a structure in which, when each molar ratio of the electrolyte salt, the carbon cluster, and the liquid compound in the liquid mixture is denoted by MS, MC, and ML, the relationship is ML≧MS≧MC.

Further, there may be a structure in which the electrolyte salt or the liquid compound has polymerizable functional groups and the liquid mixture is pectized by polymerizing the polymerizable functional groups. According to this structure, since the leakage of the electrolyte is not caused, the electrolyte having favorable ionic conductivity at low temperatures may be achieved. On addition of a polymerization initiator, the polymerizable functional groups may be polymerized due to light and/or heat.

Further, the carbon cluster may have a structure having at least one among the group consisting of fullerene, carbon nanotube, graphene, a hydride of fullerene, a hydride of carbon nanotube, a hydride of graphene, an oxide of fullerene, an oxide of carbon nanotube, an oxide of graphene, and defectives thereof. According to this structure, an electrolyte with favorable ionic conductivity at low temperatures may be achieved.

Further, the alkali metal salt may have a structure having at least one of a lithium salt, a sodium salt, and a potassium salt. According to this structure, an electrolyte with favorable ionic conductivity at low temperatures may be achieved.

In the method for producing the electrolyte according to the present invention, there may be a structure in which the liquid compound is an organic solvent having any one of ether group, ester group, and carbonyl group. According to this structure, the stable electrolyte having favorable ionic conductivity at low temperatures may be produced.

Further, the liquid compound may have a structure being an ionic liquid. According to this structure, an electrolyte, in which ionic conductivity in a wide temperature range between low-temperature and high-temperature is better than an electrolyte using a polymeric matrix; and has favorable stabilities such as heat-resistance, may be produced.

Moreover, the liquid mixture may have a structure in which, when each molar ratio of the electrolyte salt, the carbon cluster, and the liquid compound in the liquid mixture is denoted by MS, MC, and ML, the relationship is ML≧MS≧MC.

Further, there may be a structure in which the electrolyte salt or the liquid compound has polymerizable functional groups; and which has a step of polymerizing the polymerizable functional groups after the first step and thereby allowing the liquid mixture to be gelatinous. According to this structure, since the leakage of the electrolyte is not caused, the electrolyte having a favorable ionic conductivity at low temperatures may be achieved. On addition of a polymerization initiator, the polymerizable functional groups may be polymerized due to light and/or heat.

Further, there may be a structure in which the vacuum desiccation temperature in the second step is 100° C. or below. According to this structure, the electrolyte having high ionic conductivity and excellent electric property may be produced. Additionally, the vacuum desiccation condition in the second step is preferably performed under the condition that excess organic solvent or water in the system may be removed and the resultant is not decomposed.

Further, the carbon cluster may have a structure having at least one among the group consisting of fullerene, carbon nanotube, graphene, a hydride of fullerene, a hydride of carbon nanotube, a hydride of graphene, an oxide of fullerene, an oxide of carbon nanotube, an oxide of graphene, and defectives thereof. According to this structure, an electrolyte with favorable ionic conductivity at low temperatures may be achieved.

Further, the alkali metal salt may have a structure having at least one of a lithium salt, a sodium salt, and a potassium salt. According to this structure, an electrolyte with favorable ionic conductivity at low temperatures may be achieved.

The electrolyte according to the present invention is formed from a liquid mixture having an electrolyte salt containing at least one of an alkali metal salt and an alkali-earth metal salt, for example electrolyte salts such as a lithium salt containing an alkali metal salt, a liquid compound having polarity and capable of ionic dissociation of the above electrolyte salt, and carbon clusters such as fullerene, and have a structure in which the electrolyte salt is held in a matrix including a carbonaceous cluster (non-polymeric matrix).

As the lithium salt, LiN(SO₂CF₃)₂, LiN(SO₂C₂F₅)₂, LiN(SO₂CF₃)(SO₂C₂F₅), LiN(SO₂CF₃)(SO₂C₃F₇), LiN(SO₂CF₃)(SO₂C₄F₉), LiCH(SO₂CF₃)₂, LiC(SO₂CF₃)₃, LiO(SO₂CH₂CH₃), LiO(SO₂(CH₂)₅CH₃), LiO(SO₂CF₃), LiO(SO₂(CF₂)₃CF₃) and the like may be used.

As the liquid compound having polarity and dissociating an electrolyte salt into ions, ionic liquids having polarity and including 1,3-dialkylimidazolium salt, 1,2,3-trialkylimidazolium salt or the like, and organic solvents having ether group, ester group, carbonyl group or the like may be available. For example, EMITFSI (1-ethyl-3-methylimidazolium bis(trifluoromethanesulfonyl)imide), acetone, and the like may be used.

As the electrolyte salt or the liquid compound, an electrolyte salt or a liquid compound having polymerizable (cross-linkage) functional groups may be used, and a polymerizable functional group is polymerized due to light and/or heat by addition of the polymerization initiator. Consequently, the above liquid mixture becomes to be fluid gel. As the polymerizable functional group, for example groups such as vinyl, 1-propenyl, allyl, allylamide, acrylic, acryloxy, epoxy, glycidyl, and styryl may be used.

As the electrolyte salt having the polymerizable functional group, for example, 6-(methacryloyloxy)-1-hexanesulfonic acid lithium salt (C₁₀H₁₇LiO₅S), 3-(acryloyloxy)-1-propanesulfonic acid lithium salt (C₆H₉LiO₅S), 2-(acryloylamino)-2-methyl-1-propanesulfonic acid lithium salt (C₇H₁₂LiNO₄S), 4-vinylbenzenesulfonic acid lithium salt (C₈H₇LiO₃S), 4-vinylbenzenesulfonic acid lithium salt (C₈H₇LiO₃S), 1-(diallylcarbamoyl)-1,2,2,2-tetrafluoroethanesulfonic acid lithium salt (C₉H₁₀F₄LiNO₄S) and the like may be used.

As the ionic liquid of the liquid compound having the polymerizable functional group, for example, 1-allyl-3-ethyl imidazolium bromide, 1-allyl-3-ethyl imidazolium tetrafluoroborate, 1-allyl-3-ethyl imidazolium bis(trifluoromethanesulfonyl)imide, 1-allyl-3-butyl imidazolium bromide, 1-allyl-3-butyl imidazolium tetrafluoroborate, 1-allyl-3-butyl imidazolium bis(trifluoromethanesulfonyl)imide, 1,3-diallyl imidazolium bromide, 1,3-diallyl imidazolium tetrafluoroborate, 1,3-diallyl imidazolium bis(trifluoromethylsulfonyl)imide and the like may be used.

As the organic solvent of the liquid compound having the polymerizable functional group, for example acrylic acid (vinylformic acid) (CH₂═CHCOOH), methacrylic acid (CH₂═C(CH₃)COOH), vinylacetic acid (CH₂═CHCH₂COO, 3-vinyl acrylic acid (CH₂═CHCH═CHCOOH), allyl acetic acid (4-pentenoic acid) (CH₂═CH(CH₂)₂COOH), methyl vinyl ketone (CH₂═CHCOCH₃), ethyl vinyl ketone (CH₂═CHCOCH₂CH₃), allyl methyl ketone (vinylacetone) (CH₂═CHCH₂COCH₃), allyl acetone (CH₂═CH(CH₂)₂COCH₃), methyl vinyl ether (metoxyethylene) (CH₃OCH═CH₂), methyl vinyl ether (CH₂═CHOCH₃), ethyl vinyl ether (CH₂═CHOCH₂CH₃), allyl methyl ether (CH₂═CHCH₂COCH₃), vinyl ether (divinyl ether) (CH₂═CHOCH═CH₂), allyl ethyl ether (CH₂═CHCH₂COCH₂CH₃), allyl ether (diallyl ether) ((CH₂═CHCH₂)₂O), acetic acid vinyl (CH₂═CHOCOCH₃), acetic acid allyl (CH₂═CHCH₂OCOCH₃), ethoxyacetic acid vinyl (CH₂═CHOCOCH₂OCH₂CH₃), acetoacetic acid allyl (CH₂═CHCH₂OCOCH₂COCH₃), acrylic acid methyl (CH₂═CHCOOCH₃), acrylic acid ethyl (CH₂═CHCOOCH₂CH₃), acrylic acid vinyl (CH₂═CHCOOCH═CH₂), acrylic acid allyl (CH₂═CHCOOCH₂CH═CH₂), acrylic acid propyl (CH₂═CHCOO(CH₂)₂CH₃), acrylic acid butyl (CH₂═CHCOO(CH₂)₃CH₃), acrylic acid 2-methoxyethyl (CH₂═CHCOO(CH₂)₂OCH₃), acrylic acid 2-ethoxyethyl (CH₂═CHCOO(CH₂)₂OCH₂CH₃), acrylic acid 2-(methoxycarbonyl)ethyl (CH₂═CHCOO(CH₂)₂COOCH₃), acrylic acid 2-(ethoxycarbonyl)ethyl (CH₂═CHCOO(CH₂)₂COOCH₂CH₃), acrylic acid 2-cyanoethyl (CH₂═CHCOO(CH₂)₂CN), methacrylic acid methyl (CH₂═C(CH₃)COOCH₃), methacrylic acid ethyl (CH₂═C(CH₃)COOCH₂CH₃), methacrylic acid propyl (CH₂═C(CH₃)COO(CH₂)₂CH₃), methacrylic acid vinyl (CH₂═C(CH₃)COOCH═CH₂), methacrylic acid allyl (CH₂═C(CH₃)COOCH₂CH═CH₂), methacrylic acid butyl (CH₂═C(CH₃)COO(CH₂)₃CH₃), allyloxymethyl methacrylate (CH₂═C(CH₃)COOCH₂OCH₂CH═CH₂) and the like may be used.

The electrolyte according to the present invention has a favorable property at low temperatures, and thus the property is excellent and stable compared to an electrolyte including a polymeric matrix.

The electrolyte according to the present invention may be prepared by a producing method having a first step of preparing a liquid mixture by addition of an electrolyte salt containing at least one of an alkali metal salt and an alkali-earth metal salt, e.g. an electrolyte salt containing an alkali metal salt and a carbon cluster to a liquid having polarity and compound dissociating the electrolyte salt into ions; and a second step of desiccating the liquid mixture by vacuum heating.

Further, since the electrolyte salt and/or the liquid compound has (have) polymerizable functional groups, the above method has a step, following to the first step, of polymerizing the polymerizable functional groups due to light and/or heat by addition of the polymerization initiator. Thereby the liquid mixture becomes to be gelatinous.

Embodiments of the present invention will be discussed in detail with reference to drawings below.

### Embodiments

An electrolyte according to an embodiment of the present invention is a solid electrolyte used for electrochemical devices such as a battery, and contains a carbon cluster and an electrolyte salt.

Firstly, the carbon cluster and the electrolyte salt used for electrolyte formation described below will be discussed.

### [Carbon Cluster]

The “carbon cluster” refers to a substance having a carbon atom as a main element and in which several tens or hundreds of atoms are bound, or in which such bound atoms are agglutinated or crystallized.

The reason that the electrolyte contains the carbon cluster is that, unlike a polymer containing a polyethylene oxide or an ethylene oxide causing movement of a cation due to segmental motion of polymer chains, ionic conductivity at low temperatures may be kept favorably.

Examples of such carbon cluster include a spherical structure, a basket structure, a planate structure, and a cylindrical structure. These may be used individually or as a mixture of plural kinds thereof. Alternatively, a single crystal or a polycrystal thereof may be used.

Examples of the spherical structure include fullerene or the derivative thereof. Note that this derivative refers to for example, a resultant material formed by introducing atom groups such as a functional group into fullerenes, and the below-described derivatives are also applied in the same sense.

Examples of the fullerene include C₃₆, C₆₀, C₇₀, C₇₆, C₇₈, C₈₀, C₈₂, C₈₄, C₈₆, C₈₈, C₉₀, C₉₂, C₉₄ or C₉₆. Examples of the fullerene derivative include an oxide and a hydride of the above fullerene. In particular, C₆₀ fullerene or the oxide thereof is preferable, because C₆₀ fullerene or the oxide thereof is available with relative ease and as well as may secure favorable ionic conductivity at low temperatures.

Examples of the basket structure include a defective of the spherical structure. Specific examples include a defective of the above fullerene or a derivative thereof. This “defective” refers to a substance having an opening structure with for example loosing of a part of atoms in the spherical structure and that is a by-product or the like generated in producing a structure called as a soot. Note that the below-described defectives are also applied in the same sense.

Examples of the planate structure include a graphene, a derivative thereof, or a defective thereof. Further, examples of the cylindrical structure include carbon nanotube, a derivative thereof, or a defective thereof.

The carbon cluster may be preferably at least one among the group consisting of fullerene, carbon nanotube, graphene, a hydride of fullerene, a hydride of carbon nanotube, a hydride of graphene, an oxide of fullerene, an oxide of carbon nanotube, an oxide of graphene, and defectives thereof. This is because such carbon cluster may be highly effective.

### [Electrolyte Salt]

The electrolyte salt has for example an electrode reactant of a battery as a cation, and contains at least one kind of an alkali metal salt and an alkali-earth metal salt. Examples of the alkali metal salt include a lithium salt, a sodium salt, and a potassium salt.

Specific examples of a lithium salt include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium bis(trifluoromethanesulfonyl)imide (LiN(SO₂CF₃)₂), lithium bis(pentafluoroethanesulfonyl)imide (LiN(SO₂C₂F₅)₂), lithium (trifluoromethanesulfonyl)(pentafluoroethanesulfonyl)imide (LiN(SO₂CF₃)(SO₂C₂F₅)), lithium (trifluoromethanesulfonyl)(heptafluoropropanesulfonyl)imide (LiN(SO₂CF₃)(SO₂C₃F₇)), lithium (trifluoromethanesulfonyl)(nonafluorobutanesulfonyl)imide (LiN(CF₃SO₂)(SO₂C₄F₉)), lithium 1,2-perfluoroethanedisulfonyl imide, lithium 1,3-perfluoropropanedisulfonyl imide, lithium 1,3-perfluorobutanedisulfonyl imide, lithium 1,4-perfluorobutanedisulfonyl imide, and lithium tris(trifluoromethanesulfonyl)methide (LiC(SO₂CF₃)₃). Such a salt may be used individually, or as a mixture of plural kinds thereof.

In the electrolyte, the ratio (molar ratio) between the molar number of the carbon cluster (M1) and the molar number of the electrolyte salt (M2) i.e. M1/M2 may be optional, and preferably within the range of 1/4 or more and 4/1 or less. This is because such ratio may be highly effective.

Formation of the electrolyte will be described below.

### [Electrolyte Formation According to First Structure]

The electrolyte according to the first structure is an electrolyte formed of an electrolyte salt and a carbon cluster, and further may be a solid electrolyte containing at least one kind of an alkali metal salt and an alkali-earth metal salt and a carbon cluster.

In production of the electrolyte according to the first structure, it is preferable that for example a given amount of carbon cluster and a given amount of an electrolyte salt in the solid-state be mixed during grinding, and thereby the above electrolyte may be easily produced.

Since the electrolyte according to the first structure is a solid electrolyte and contains an electrolyte salt having a carbon cluster and at least one kind of an alkali metal salt and an alkali-earth metal salt, unlike an existing solid electrolyte including polymers such as polyethylene oxide and an electrolyte salt, ionic conductivity may be favorably kept within a wide temperature range without the drastic reduction of ionic conductivity caused by inhibition of segmental motion of polymer chains at low temperatures. It is to be noted that the electrolyte according to the first structure may be a powder mixture containing a carbon cluster and an electrolyte salt, or a solidified thereof.

According to the electrolyte according to the first structure, since a carbon cluster is contained, although the electrolyte is a solid electrolyte, ionic conductivity at low temperatures is allowed to be favorable compared to an electrolyte formed of a polymeric matrix. Therefore, according to the battery with this electrolyte, since reduction of ionic conductivity at low temperatures is prevented, the property of the battery may be favorably kept.

According to the electrolyte according to the first structure, since a carbon cluster is contained, although the electrolyte is a solid electrolyte, favorable ionic conductivity at low temperatures may be secured. Therefore, according to the electrochemical devices such as a battery with this electrolyte, since reduction of ionic conductivity at low temperatures is prevented, the property of the battery may be favorably kept.

Further, when the carbon cluster is preferably at least one kind among the group consisting of fullerene, carbon nanotube, graphene, a hydride of fullerene, a hydride of carbon nanotube, a hydride of graphene, an oxide of fullerene, an oxide of carbon nanotube, an oxide of graphene, and defectives thereof or when the electrolyte salt is at least one kind of lithium salt, sodium salt and potassium salt, high effect may be obtained.

In the above description, the electrolyte according to the first structure is discussed.

### [Electrolyte Formation According to Second Structure]

The electrolyte according to a second structure is an electrolyte formed of an electrolyte salt, a carbon cluster, and a polar organic solvent, and further may be a solid electrolyte formed of an electrolyte salt having at least an alkali metal salt, a carbon cluster, and an organic solvent having polarity and allowing ionic dissociation of this electrolyte salt.

According to the electrolyte according to the second structure, ionic conductivity at low temperatures may be favorable compared to the electrolyte according to the first structure. Therefore, the battery with this electrolyte may maintain a favorable battery property as reduction of ionic conductivity at low temperatures is prevented.

### [Electrolyte Formation According to Third Structure]

The electrolyte according to a third structure is an electrolyte formed of an electrolyte salt, a carbon cluster, and an ionic liquid, and further may be a solid electrolyte formed of an electrolyte salt having at least an alkali metal salt, a carbon cluster, and an ionic liquid having polarity and allowing ionic dissociation of this electrolyte salt.

Additionally, in the formation of the electrolyte according to the third structure, a solid molten salt is dissolved by using an organic solvent and the resultant material may be used as an ionic liquid.

According to the electrolyte according to the third structure, ionic conductivity in a wide temperature range from low-temperature to high-temperature may be favorable compared to the electrolyte according to the second structure, and stabilities such as heat-resistance may be favorable. Therefore, the battery with this electrolyte may maintain a favorable battery property at a wide range of temperatures as reduction of ionic conductivity at low temperatures is prevented.

### [Electrolyte Formation According to Fourth Structure]

An electrolyte according to a fourth structure is an electrolyte formed of an obtained substance by giving a polymerizable (cross-linkage) functional group to a liquid compound having polarity and dissociating an electrolyte salt into ions and/or an electrolyte salt, and a carbon cluster. This electrolyte is a solid electrolyte formed of an electrolyte salt having at least an alkali metal salt, the above liquid compound, and a carbon cluster, and the electrolyte salt and/or the above liquid compound have (has) polymerizable (cross-linkage) functional group. The above liquid compound is an organic solvent or an ionic liquid.

According to the electrolyte according to the fourth structure, there is a favorable ionic conductivity at low temperatures. Further according to the battery with this electrolyte, the electrolyte may maintain favorable battery property as reduction of ionic conductivity at low temperatures is prevented. Further according to the electrolyte according to the fourth structure, an electrolyte film having mechanical strength may be obtained, and the battery with this electrolyte may be constituted without limitations to the shape, size and the like.

Next, examples for using the electrolytes according to the first to the fourth structures will be discussed. As one example of electrochemical devices, when a battery is exemplified, the electrolyte may be used in the following manner.

### [First Battery]

FIG. 1 is a cross sectional view illustrating the structure of the first battery according to an embodiment of the present invention.

The battery shown in FIG. 1 is for example, a lithium ion secondary battery in which the capacity of an anode represents the capacity based on insertion and extraction of lithium as a battery reactant.

In this secondary battery, a cathode 14 contained in a package can 11 and an anode 15 contained in a package cup 12 are layered with an electrolyte 16 in between. The battery structure using the package can 11 and the package cup 12 is a so-called coin type battery.

Peripheral edges of the package can 11 and the package cup 12 are hermetically sealed by being caulked with a gasket 13. The package can 11 has a shape of a shallow plate to contain the cathode 14, that is, a shape of a so-called a petri dish, and becomes an external cathode of the secondary battery. The package can 11 is composed of, for example, stainless, aluminum (Al), a metal having a structure in which aluminum, stainless, and nickel (Ni) are sequentially layered in the thickness direction from the cathode 14 side, or the like.

Further, the package cup 12 is a container having a shape of a petri dish and containing the anode 15, and becomes an external anode of the secondary battery. The package cup 12 is composed of metals such as stainless, aluminum, and iron (Fe) plated with nickel on the surface. The gasket 13 is composed of, for example, an insulating material.

The cathode 14 has a structure in which, for example, a cathode active material layer 14B is provided on a single face of a cathode current collector 14A having a pair of opposed faces. The cathode current collector 14A is composed of, for example, metal materials such as aluminum, nickel, and stainless. The cathode active material layer 14B contains, for example, as a cathode active material, any one or two or more cathode materials capable of inserting and extracting lithium as an electrode reactant. The cathode active material layer 14B may contain an electrical conductor, a binder or the like as needed.

Examples of the cathode material capable of inserting and extracting lithium include chalcogen compounds not containing lithium such as iron sulfide (FeS₂), titanium sulfide (TiS₂), molybdenum sulfide (MoS₂), niobium selenide (NbSe₂), and vanadium oxide (V₂O₅), or a lithium-containing compound that contains lithium.

Specifically, the lithium-containing compound is preferable as some of them have high voltages and high energy densities may be obtained. Examples of such a lithium-containing compound include a composite oxide containing lithium and a transition metal element and a phosphate compound containing lithium and a transition metal element. In particular, a compound containing at least one kind among the group consisting of cobalt, nickel, manganese, and iron is preferable. This is because a higher voltage is obtained in the compound. The chemical formula may be expressed by, for example, LiₓMIO₂ or Li_{y}MIIPO₄. In the formula, MI and MII represent one or more kinds of transition metal elements. Values of x and y vary according to the charge and discharge state of a battery, and are generally in the range of 0.05≦x≦1.10 and 0.05≦y≦1.10.

Specific examples of the composite oxide containing lithium and a transition metal element include a lithium cobalt composite oxide (LiₓCoO₂), a lithium nickel composite oxide (LiₓNiO₂), a lithium nickel cobalt composite oxide (LiₓNi_{1-z}Co_{z}O₂ (z<1)), a lithium nickel cobalt manganese composite oxide (LiₓNi(_{1-v-w})CoᵥMn_{w}O₂) (v+w<1)), and lithium manganese composite oxide (LiMn₂O₄) having a spinel structure.

Specifically, a composite oxide containing nickel is preferable. This is because a high capacity is obtained and superior cycle characteristics are obtained. Specific examples of the phosphate compound containing lithium and a transition metal element include lithium iron phosphate compound (LiFePO₄) and a lithium iron manganese phosphate compound (LiFe₁₋ᵤMnᵤPO₄ (u<1)).

In addition, examples of the above cathode material include oxides such as titanium oxide, vanadium oxide, and manganese dioxide; sulfur; and conductive polymers such as polyaniline and polythiophene.

The anode 15 has a structure in which, for example, an anode active material layer 15B is provided on a single face of an anode current collector 15A having a pair of opposed faces. The anode current collector 15A is preferably composed of a metal material having favorable electrochemical stability, electric conductivity, and mechanical strength. Examples of the metal material include copper (Cu), nickel, and stainless. Specifically, as the metal material, copper is preferable. This is because high electric conductivity may be obtained.

In particular, as the metal material composing the anode current collector 15A, a metal material containing one or two or more kinds of metal elements not forming an intermetallic compound with lithium is preferable. When the intermetallic compound is formed with lithium, since stress due to expansion and shrinkage of the anode current collector 15A in charge and discharge causes damage, current collectivity may be lowered, and the anode active material layer 15B may be easily separated. Examples of the metal element include copper, nickel, titanium (Ti), iron, and chromium (Cr).

The anode active material layer 15B contains, as an anode active material, any one or two or more kinds of anode materials capable of inserting and extracting lithium. The anode active material layer 15B may contain an electrical conductor, a binder and the like as needed. Additionally, the charge capacity of the anode material capable of inserting and extracting lithium is preferably larger than the charge capacity of the cathode active material.

Examples of the anode material capable of inserting and extracting lithium include a carbon material. Examples of the carbon material include graphitizable carbon, non-graphitizable carbon in which the spacing of (002) plane is 0.37 nm or more, and graphite in which the spacing of (002) plane is 0.34 nm or less.

More specific examples thereof include pyrolytic carbons, cokes, graphite, glassy carbon fiber, an organic polymer compound fired body, carbon fiber, activated carbon, and carbon blacks. In the above examples, the cokes include pitch coke, needle coke, petroleum coke and the like. The organic polymer compound fired body is obtained by firing at appropriate temperature and carbonizing a phenol resin, a furan resin or the like. In the carbon material, the crystal structure change associated with inserting and extracting lithium is very little. Therefore, a high energy density is thereby obtained and superior cycle characteristics are thereby obtained. Further, since the carbon material also functions as an electrical conductor, the carbon material is preferably used.

Moreover, examples of the anode material capable of inserting and extracting lithium include a material that is capable of inserting and extracting lithium and has at least one kind of metal elements and metalloid elements as a constituent element. Such an anode material is preferable as a high energy density is thereby obtained. Such an anode material may be a simple substance, an alloy, or a compound of a metal element or a metalloid element, or may have one kind or two or more kinds of phases thereof at least in part. An alloy described herein includes an alloy containing one or more kinds of metal elements and one or more kinds of metalloid elements, in addition to an alloy composed of two or more kinds of metal elements. Further, the alloy described herein may contain a nonmetallic element. The texture thereof includes a solid solution, an eutectic crystal (eutectic mixture), an intermetallic compound, and a texture in which two or more kinds thereof coexist.

Examples of the metal element or the metalloid element composing the anode material include a metal element or a metalloid element capable of forming an alloy with lithium. Specific examples include magnesium (Mg), boron (B), aluminum, gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd), and platinum (Pt). Specifically, at least one of silicon and tin is preferable as silicon and tin have high ability to insert and extract lithium, and provide a high energy density.

Examples of a material containing at least one of silicon and tin include at least one kind among the group consisting of a simple substance, an alloy, and a compound of silicon; and a simple substance, an alloy, and a compound of tin. That is, the material has a simple substance, an alloy, or a compound of silicon; a simple substance, an alloy, or a compound of tin; and one kind or two or more kinds of phases thereof at least in part.

Examples of the alloy of silicon include an alloy containing at least one kind among the group consisting of tin, nickel, copper, iron, cobalt (Co), manganese (Mn), zinc, indium, silver, titanium, germanium, bismuth, antimony (Sb), and chromium as the second constituent element other than silicon. Examples of the alloy of tin include an alloy containing at least one kind among the group consisting of silicon, nickel, copper, iron, cobalt, manganese, zinc, indium, silver, titanium, germanium, bismuth, antimony, and chromium as the second constituent element other than tin.

Examples of the compound of silicon or the compound of tin include a compound containing oxygen (O) or carbon (C). In addition to silicon or tin, the compound of silicon or the compound of tin may contain the above second constituent element.

In particular, as the material containing at least one of silicon and tin, a material containing the second constituent element and the third constituent element in addition to tin as the first constituent element is preferable. The second constituent element is at least one kind among the group consisting of cobalt, iron, magnesium, titanium, vanadium (V), chromium, manganese, nickel, copper, zinc, gallium, zirconium, niobium (Nb), molybdenum (Mo), silver, indium, cerium (Ce), hafnium, tantalum (Ta), tungsten (W), bismuth, and silicon. The third constituent element is at least one kind among the group consisting of boron, carbon, aluminum, and phosphorus. Because of containing the second constituent element and the third constituent element, the cycle characteristics are improved.

Specifically, a CoSnC-containing material that contains tin, cobalt, and carbon as a constituent element, in which the carbon content is in the range of 9.9 wt % or more and 29.7 wt % or less, and the cobalt ratio to the total of tin and cobalt (Co/(Sn+Co)) is in the range of 30 wt % or more and 70 wt % or less is preferable. In such a composition range, a high energy density can be obtained.

The CoSnC-containing material may further contain other element as needed. As other constituent element, for example, silicon, iron, nickel, chromium, indium, niobium, germanium, titanium, molybdenum, aluminum, phosphorus, gallium, bismuth or the like is preferable and CoSnC-containing material may contain two or more kinds thereof In the result, higher effect may be obtained.

Additionally, the CoSnC-containing material has a phase containing tin, cobalt, and carbon. Such a phase preferably has a low crystalline structure or an amorphous structure. Further, in the CoSnC-containing material, at least a part of carbons as a constituent element is preferably bonded to a metal element or a metalloid element as other constituent elements. This is because cohesion or crystallization of tin or the like is prevented.

Further, examples of a measurement method for examining bonding state of elements include X-ray Photoelectron Spectroscopy (XPS). In XPS, in the case of graphite, the peak of 1 s orbit of carbon (C1's) is shown in 284.5 eV in the device in which energy calibration is made so that the peak of 4f orbit of gold atom (Au4f) is obtained at 84.0 eV. In the case of surface contamination carbon, the peak is shown at 284.8 eV.

In contrast, when higher charge density of a carbon element becomes high, for example, when a carbon is bonded to a metal element or a metalloid element, the peak of C1 s is shown in the region lower than 284.5 eV. That is, when the peak of composite wave of C1 s obtained for the CoSnC-containing material is shown in a region lower than 284.5 eV, at least a part of carbons contained in the CoSnC-containing material is bonded to the metal element or the metalloid element as other constituent element.

Additionally, in XPS, for example, the peak of C1 s is used for calibrating the energy axis of spectrums. Since surface contamination carbon generally exists on a material surface, the peak of C1 s of the surface contamination carbon is set to in 284.8 eV, which is used as an energy reference. In XPS, the waveform of the peak of C1 s is obtained as a form including the peak of the surface contamination carbon and the peak of carbon in the CoSnC-containing material. Therefore, for example, by performing analysis by using commercially available software, the peak of the surface contamination carbon and the peak of carbon in the CoSnC-containing material are separated. In the analysis of the waveform, the position of the main peak existing on the lowest binding energy side is set to the energy reference value (284.8 eV).

Further, examples of the anode material capable of inserting and extracting lithium include a metal oxide, a polymer compound and the like capable of inserting and extracting lithium. Examples of the metal oxide include iron oxide, ruthenium oxide, molybdenum oxide and the like. Examples of the polymer compound include polyacetylene, polyaniline, polypyrrole and the like.

It is needless to say that some of the above anode materials capable of inserting and extracting lithium may be used in combination.

Examples of the electrical conductor include carbon materials such as graphite, carbon black, and Ketjen black. Such a carbon material may be used individually, or as a mixture of plural kinds thereof. Additionally, the electrical conductor may be a metal material, a conductive polymer molecule or the like as long as the material has the electric conductivity.

Examples of the binder include synthetic rubbers such as styrene-butadiene rubber, fluorinated rubber, and ethylene propylene diene; and polymer materials such as polyvinylidene fluoride. These binders may be used individually, or as a mixture of plural kinds thereof.

The electrolyte 16 is composed of the above electrolytes according to the first to fourth structures as favorable battery characteristics may be retained at low temperatures. Further, since the electrolyte 16 is the solid electrolyte, liquid leakage, decomposition of the electrolyte and the like are not caused, and superior safety and superior cycle characteristics are obtained, differently from a case that an electrolyte in which an electrolytic solution is retained by a polymer compound (gel electrolyte) or a liquid electrolyte (electrolytic solution) is used.

When the secondary battery is manufactured, for example, the cathode 14, the electrolyte 16, and the anode 15 are layered, and the resultant laminated body is contained in the package can 11. Further, the package cup 12 is put on the peripheral part of the package can 11, and the resultant is caulked and fixed through the gasket 13. Accordingly, the secondary battery illustrated in FIG. 1 is completed.

In the secondary battery, when charged, for example, lithium ions are extracted from the cathode 14 and inserted in the anode 15 through the electrolyte 16. In contrast, when discharged, for example, lithium ions are extracted from the anode 15 and inserted in the cathode 14 through the electrolyte 16.

According to the secondary battery, when the capacity of the anode 15 is expressed by the capacity component based on insertion and extraction of lithium, since the above electrolyte according to the first to fourth structures is included, reduction of ion conductance at low temperatures of the electrolyte 16 is prevented, and thereby favorable battery properties may be maintained. Further, since the electrolyte 16 is the solid electrolyte, liquid leakage that may be caused if a liquid electrolyte or an electrolyte in which an electrolytic solution is retained by a polymer compound is used is not generated, and decomposition of the electrolyte is prevented even if charge and discharge are repeated. Therefore, the electrolyte may contribute to improvement of safety and cycle characteristics. Further, compared to a case of a liquid electrolyte or an inorganic solid electrolyte, weight of the entire battery may be reduced.

### [Second Battery]

The second battery has a structure, action, and effect similar to those of the first battery except that the structure of the anode 15 is different from that of the first battery, and is manufactured in procedure similar to that of the first battery. For common constituent elements with the first battery, the description will be omitted herein.

The anode 15 has a structure in which, the anode active material layer 15B is provided on a single face of the anode current collector 15A as in the first battery. The anode active material layer 15B contains, for example, as an anode active material, a material containing silicon or tin as a constituent element. In particular, for example, the anode active material layer 15B contains a simple substance, an alloy, or a compound of silicon or a simple substance, an alloy, or a compound of tin, and may contain two or more kinds thereof.

The anode active material layer 15B is formed by using vapor-phase deposition method, liquid-phase deposition method, spraying method, firing method, or a combination of two or more of these methods. The anode current collector 15A and the anode active material layer 15B are preferably alloyed in at least part of the interface thereof. In particular, at the interface thereof, the constituent element of the anode current collector 15A is preferably diffused in the anode active material layer 15B; or the constituent element of the anode active material layer 15B is preferably diffused in the anode current collector 15A; or these elements are preferably diffused in each other. Thereby, destruction due to expansion and shrinkage of the anode active material layer 15B associated with charge and discharge is prevented, and the electron conductivity between the anode active material layer 15B and the anode current collector 15A is able to be improved.

Additionally, examples of vapor-phase deposition method include physical deposition method and chemical deposition method, and specific examples thereof include vacuum deposition method, sputtering method, ion plating method, laser ablation method, thermal Chemical Vapor Deposition (CVD) method, plasma CVD method, and the like. As liquid-phase deposition method, well-known techniques such as electrolytic plating and electroless plating may be used. Firing method is, for example, a method in which after coating is provided by mixing a particulate anode active material with a binder and the like to disperse the resultant mixture in a solvent, heat treatment is provided at temperatures higher than the melting point of the binder or the like. For firing method, well-known techniques such as atmosphere firing method, reactive firing method, and hot press firing method may be used as well.

Specific examples according to the present invention will be described in detail below.

### EXAMPLES

### Example 1-1

### Preparation of Electrolyte by Dry Mixing Method

As a carbon cluster used for Example 1-1 and Examples 1-2 and 1-3 described below, a fullerene oxide was used to prepare the above electrolyte according to the first structure.

Initially, a fullerene oxide was synthesized. In this case, 300 cm³ of a toluene solution (1 mmol/dm³) of C₆₀ as fullerene (nanon purple, manufactured by Frontier Carbon Corporation, purity of 99% or more) was set in a three-neck flask attached with a thermometer, and the three-neck flask was heated up to 80° C. by an oil bath. After that, ozone gas (concentration: 30 g/m³) was introduced into the three-neck flask at a flow rate of 1.0 dm³/min. The toluene solution was bubbled for 300 seconds, and thereby the reaction for oxidizing C₆₀ was allowed to proceed. At that time, temperature of the reacted toluene solution was lowered down to about 71° C. to 73° C.

Subsequently, nitrogen gas was introduced into the three-neck flask for 300 seconds, and thereby the ozone gas in the three-neck flask was removed and the reaction was stopped. The toluene solution was stirred for 30 minutes at 80° C. After that, by cooling down to room temperature, a fullerene oxide-containing toluene solution was obtained. Next, 1 dm³ of toluene was added to the fullerene oxide-containing toluene solution, which was refluxed for 1 hour, and then cooled down to room temperature.

Subsequently, the refluxed fullerene oxide-containing toluene solution was filtered and separated into an insoluble portion and a soluble portion by a polytetrafluoroethylene (PTFE) membrane filter having a pore diameter of 1.0 μm. At this time, the insoluble portion contained C₆₀Oₓ (x>6) as fullerene oxide, and the soluble portion contained C₆₀Oₓ (0<x≦6) as fullerene oxide. Finally, the insoluble portion was dried in vacuum at 80° C., and thereby C₆₀Oₓ (x>6) was obtained.

Subsequently, in a glove box under argon atmosphere, C₆₀Oₓ (x>6) as synthesized fullerene oxide and lithium bis(trifluoromethanesulfonyl)imide (Li⁺[(CF₃SO₂)₂N]⁻, LiTFSI manufactured by Sigma-Aldrich Co.) as a lithium salt as an electrolyte salt were grinded and mixed for about 10 minutes in a mortar, and thereby an electrolyte was formed. At this time, mixing was performed so that the ratio (molar ratio) M1/M2 between the number of moles of C₆₀Oₓ (x>6) as carbon cluster (M1) and the number of moles of LiTFSI as an electrolyte salt (M2) became 1/1.

### Examples 1-2 and 1-3

### Preparation of Electrolyte by Dry Mixing Method

A procedure was taken in the same manner as in Example 1-1, except that the molar ratio M1/M2 was 1/2 (Example 1-2) or 1/4 (Example 1-3) instead of 1/1.

### Example 1-4

### Preparation of Electrolyte by Dry Mixing Method

A procedure was taken in the same manner as in Example 1-1, except that lithium hexafluoroarsenic acid(LiAsF₆) was used instead of LiTFSI as an electrolyte salt. At this time, mixing was performed so that the ratio (molar ratio) M1/M2 between the number of moles of C₆₀Oₓ (x>6) as carbon cluster (M1) and the number of moles of LiAsF₆ as an electrolyte salt (M2) became 1/1.

### Comparative Example 1

### Preparation of Electrolyte by Wet Mixing Method

An electrolyte composed of polyethylene oxide (PEO) and LiTFSI was formed so that the ratio (EO:Li) between the number of moles of ethylene oxide (EO) as monomer unit of PEO and the number of moles of lithium (Li) contained in LiTFSI became 10:1. In this case, in a glove box under argon atmosphere, 0.5 g of polyethylene oxide (molar weight: 100000 manufactured by Sigma-Aldrich Co.) and 0.0326 g of LiTFSI were dissolved in 50 cm³ of acetonitrile, and the obtained solution was stirred for 12 hours. Next, the stirred solution was set in a petri dish composed of PTFE, which was air-dried under argon atmosphere. After that, by drying under vacuum atmosphere at 80° C., an electrolyte was formed.

For the electrolytes of these Examples 1-1 to 1-4 and Comparative Example 1, impedance was measured at from −20° C. to 80° C. both inclusive to examine temperature characteristics of ionic conductivity. In measuring impedance, in a dry room, after temperature of the electrolytes reached at given temperature and the electrolytes were retained for 1 hours, ionic conductivity (σ; S/cm) was measured.

FIG. 2 is a diagram illustrating the temperature property of ionic conductivity of electrolytes in Examples 1-1 to 1-4 according to the present invention and Comparative Example 1.

FIG. 2 illustrates Arrhenius plots based on each ionic conductivity value at each temperature, in which the vertical axis represents ionic conductivity σ in logarithmic scale and the horizontal axis represents inverse of temperature value T (absolute temperature; K), i.e. T-1(K-1).

As shown in FIG. 2, in Examples 1-1 to 1-4 in which C₆₀Oₓ (x>6) was contained, there was a tendency that when the temperature was 50° C. or more (3.1×10⁻³ K⁻¹ or less), ionic conductivity became almost constant, and when temperature was lower than 50° C. (rose above 3.1×10⁻³ K⁻¹), ionic conductivity was moderately lowered. In contract, in Comparative Example 1 in which PEO was contained, since temperature was lowered, ionic conductivity was rapidly lowered, and the absolute value of the slope of Examples 1-1 to 1-4 was smaller than that of Comparative Example 1.

The result shows that while in the electrolyte containing polymer compounds such as polyethylene oxide, as temperature was lowered, fragment movement of polymer chains was prevented and ionic conductivity was significantly lowered, in the electrolyte containing C₆₀Oₓ (x>6) as fullerene oxide, the reduction of ionic conductivity at low temperatures was prevented.

Accordingly, it was confirmed that the solid electrolytes in Examples may secure favorable ionic conductivity at low temperatures because of containing the fullerene derivative and the lithium salt. Therefore, it may be considered that a battery with such an electrolyte has favorable battery properties retained at low temperatures.

Further, in comparison among Examples 1-1 to 1-3, it was found that when the temperature is 50° C. or more, as the ratio (molar ratio) of LiTFSI in the electrolyte is increased, ionic conductivity is increased. In addition, it was found that when molar ratio M1/M2 between C₆₀Oₓ (x>6) and LiTFSI is 1/2, high and stable ionic conductivity is obtained in a wide temperature range. Further, in comparison between Example 1-1 and Example 1-4, it was suggested that in the electrolyte containing fullerene oxide, higher ionic conductivity was obtained in the case of using LiAsF₆ as an electrolyte salt than in the case of using LiTFSI as an electrolyte salt.

### Examples 2-1 and 2-2

### Preparation of Electrolyte by Dry Mixing Method

A procedure was taken in the same manner as in Example 1-1 or Example 1-4, except that C₆₀ as fullerene was used instead of C₆₀Oₓ (x>6) as a carbon cluster. At this time, as an electrolyte salt, LiTFSI (Example 2-1) or LiAsF₆ (Example 2-2) was used. In both examples, the molar ratio M1/M2 between the carbon cluster and the electrolyte salt was 1/1.

In these Examples 2-1 and 2-2, the temperature property of each ionic conductivity was examined similarly to in Example 1-1.

FIG. 3 is a diagram illustrating the temperature property of ionic conductivity of electrolytes in Examples 2-1 and 2-2 according to the embodiment of the present invention, and Comparative Example 1.

FIG. 3 illustrates Arrhenius plots based on each ionic conductivity value at each temperature, in which the vertical axis represents ionic conductivity σ in logarithmic scale and the horizontal axis represents inverse of temperature value T (absolute temperature; K), i.e. T-1(K-1).

As shown in FIG. 3, in use of C₆₀, the results similar to the results shown in FIG. 2 were obtained. That is, in Examples 2-1 and 2-2 in which C₆₀ was contained, there was a tendency that when temperature was 50° C. or more, ionic conductivity became almost constant, and when temperature was lower than 50° C., ionic conductivity was moderately lowered. Further, the absolute value of the ionic conductivity slope that was lowered as temperature was lowered of Examples 2-1 and 2-2 was smaller than that of Comparative Example 1. That is, it was shown that in the case of the electrolyte containing C₆₀, the reduction of ionic conductivity at low temperatures was prevented as well.

Accordingly, it was confirmed that the solid electrolytes in these Examples may secure favorable ionic conductivity at low temperatures because of containing the fullerene and the lithium salt. Therefore, it may be considered that a battery with such an electrolyte has favorable battery properties retained at low temperatures.

Further, in comparison between Examples 2-1 and 2-2, it was also suggested that also in the electrolyte containing fullerene, higher ionic conductivity is obtained by using LiAsF₆ as an electrolyte salt compared to LiTFSI.

Further, from the results of FIG. 2 and FIG. 3, it was confirmed that the solid electrolyte containing carbon cluster may secure favorable ionic conductivity at low temperatures without relation to the carbon cluster type. In particular, it was confirmed that higher ionic conductivity was obtained by using fullerene compared to a fullerene oxide.

As described above, the electrolyte property obtained by mixing the carbon cluster and the Li salt in the solid-state during grinding, that is, producing the electrolyte (electrolyte according to the first structure) by the dry mixing method is discussed.

Next, more complete mixing of a carbon cluster and Li salt was attempted, and thus an electrolyte was produced by a wet mixing method. Accordingly, the property of the obtained electrolyte will be discussed.

FIG. 4 is a diagram illustrating temperature properties of ionic conductivity of electrolytes in Examples 3 to 5 described below according to the present invention and Comparative Example 1.

In FIG. 4, the horizontal axis represents inverse of temperature (10³T⁻¹/K⁻¹), and the vertical axis represents ionic conductivity (S/cm). Further, (a) WetC60+LiTFSI(1.0/1.0) vaccuo@100 C represents the ionic conductivity of the electrolyte obtained by Example 3 (Wet Mixing Method); (b) WetC60+LiTFSI(1.0/1.0) vaccuo@150 C represents the ionic conductivity of the electrolyte obtained by Example 4 (Wet Mixing Method); (c) C60+LiTFSI+BMI-TFSI(1.0/1.0/1.36) represents the ionic conductivity of the electrolyte obtained by Example 5 (Wet Mixing Method); (d) DRYC60+LiTFSI(1.0/1.0) represents the ionic conductivity of the electrolyte obtained by Example 2-1 (Dry Mixing Method) (the same data as shown in FIG. 3); and (e) Ref.PEO+LiTFSI(0.1) represents the ionic conductivity of the electrolyte obtained by Comparative Example 1 (the same data as shown in FIG. 3).

FIG. 5 is a diagram illustrating TG curves of C₆₀, LiTFSI, and an electrolyte in Examples described below according to the present invention.

In FIG. 5, the horizontal axis represents temperature (°C.) and the vertical axis represents weight remaining ratio (%). Further, (a) represents a TG curve of a simple substance of C₆₀; (b) represents a simple substance of LiTFSI thereof (c) represents a mixture (C₆₀+LiTFSI) thereof (d) represents an electrolyte according to Example 3 thereof and (e) represents an electrolyte according to Example 4 thereof.

As shown in (a) of FIG. 5, the simple substance of C₆₀ showed little weight loss until the temperature reached about 500° C. As shown in (b) of FIG. 5, the simple substance of LiTFSI showed apparent weight loss at about 330° C., and in this weight loss, the approximately linear change at the temperature from about 370° C. to a higher temperature is observed. Further as shown in (c) of FIG. 5, the mixture (C₆₀+LiTFSI) showed apparent weight loss at about 370° C., and in this weight loss, the approximately linear change at a temperature between about 430° C. and about 470° C. is observed.

### <Example 3

### Preparation of Electrolyte by Wet Mixing Method

The electrolyte described in Example 3 is an electrolyte according to the above second structure, and LITFSI as an electrolyte salt, fullerene C₆₀ as a carbon cluster, and an acetone as a polar organic solvent are used to be respectively mixed into a mortar, and subsequently the resultant material was subjected to vacuum desiccation under heating and thereby the electrolyte was formed.

In a dry room, 1 mol/L acetone solution of LiTFSI 13.9 mL (LiTFSI 0.139 mmol) and 0.100 g of C₆₀ (0.139 mmol) were mixed in a mortar for about 40 minutes. Initially, it was anticipated that a powder mixture would be obtained because of volatilization of acetone, and however, a black gelatinous substance having viscosity was obtained. Further, when continuing mixing, the mixture remained fluid gel. Subsequently, the obtained mixture was subjected to vacuum desiccation at 100° C. for 12 hours, but the mixture remained gelatinous. Thus, it was anticipated that acetone was included in an optional form. Accordingly, the impedance measurement and TG (thermogravimetry)/DTA (Differential Thermal Analysis) were performed on the obtained dry mixture. It is to be noted that in the impedance measurement, 12608W electrochemical analysis device, Solartron products, was used, and in TG/DTA measurement, 220-TG/DTA thermal analysis device, Seiko Instruments Inc. products, was used.

As shown in (a) of FIG. 4, the Arrhenius plots expressing the ionic conductivity of the dry mixture obtained in Example 3 is different from these of the electrolyte in Example 2-1 (Dry Mixing Method) shown in (d) of FIG. 4, and is similar to these in Comparative Example 1 shown in (e) of FIG. 4. That is, the Arrhenius plots in Example 3 indicate that as temperature increases, ionic conductivity linearly increases. Additionally, the ionic conductivity of the obtained dry mixture in Example 3 was favorable compared to the ionic conductivity of the electrolyte containing a polymeric matrix in Comparative Example 1 shown in (e) of FIG. 4, and for example, ionic conductivity at 30° C. was 1.5×10⁻⁵ S/cm.

As shown in (d) of FIG. 5, the TG/DTA measurement of the obtained dry mixture in Example 3 shows that while showing little weight loss at about 130° C. or less, above this temperature, the obtained dry mixture shows apparent weight loss. It is considered that the weight loss at between 180° C. and 300° C. in (d) of FIG. 5 is caused by the presence of acetone retained in the electrolyte, and the weight loss at about 390° C. or more is caused by the presence of LiTFSI.

From these results, the sample of the obtained dry mixture in Example 3 was presumed a following structure. That is, it is considered that LiTFSI solvated in acetone (possibility of ionic dissociation of LiTFSI due to a carbonyl group of acetone) is mixed with fullerene, and thereby Li cation, TFSI anion or polarized acetone existing between C₆₀ and C₆₀ causes interaction between molecules, and as a result, the sample of the obtained dry mixture in Example 3 becomes a fluid mixture.

### Example 4

### Preparation of Electrolyte by Wet Mixing Method

The electrolyte shown in Example 4 is obtained by desiccating the obtained mixture in Example 3 under higher temperatures in vacuum.

For the purpose of removal of acetone included in the sample of the obtained dry mixture in Example 3, the desiccated mixture further was subjected to vacuum desiccation at 150° C. for 48 hours. Subsequently, the impedance measurement and TG/DTA analysis for the obtained dry substance were performed in the same manner as in Example 3.

After the vacuum desiccation at 150° C., the dry mixture lost much of the flexibility and was in state of proceeding solidification. However, the dry mixture had low viscosity, and thus it was considered that acetone remained in the dry mixture. Further, a clear solid material was attached to the upper part of a sample tube employed in vacuum desiccation. Therefore, it was found that LiTFSI had been sublimed, and accordingly it was presumed that ionic conductivity reduced.

As shown in (b) of FIG. 4, the ionic conductivity of the obtained dry mixture in Example 4 was approximate 100-times lower than that in Example 3 (See (a) of FIG. 4).

As shown in (e) of FIG. 5, the TG/DTA measurement result of the obtained dry mixture in Example 4 shows that while showing little weight loss at about 130° C. or less, above this temperature, the obtained dry mixture shows apparent weight loss. The weight loss of the obtained dry mixture in Example 4 is greater than that in Example 3. It is considered that the weight loss at between 180° C. and 300° C. in (e) of FIG. 5 is caused by the presence of acetone retained in the electrolyte, and the weight loss at about 390° C. or more is caused by the presence of LiTFSI.

From the result of TG/DTA shown in (e) of FIG. 5, reductions of acetone and LiTFSI were recognized, so it is considered that the above reduction of ionic conductivity is caused by reduction of acetone to accelerate dissociation of LiTFSI and sublimation of LiTFSI in the obtained dry mixture in Example 4 as the vacuum desiccation temperature rose from 100° C. to 150° C.

### Example 5

### Preparation of Electrolyte by Wet Mixing Method

When polar solvents such as acetone are used for wet mixing, the obtained mixture is pectized by dry process as described above. Instead of acetone, an ionic liquid devised as a more polar liquid in which a polar solvent is not volatilized during drying was used for an examination.

The electrolyte described in Example 5 has the same structure as the above electrolyte of the third structure, and was formed of LiTFSI as an electrolyte salt, fullerene C₆₀ as a carbon cluster, and EMITFSI (1-ethyl-3-methyl imidazolium bis(trifluoromethanesulfonyl)imide) as an ionic liquid, which were mixed in a mortar, and the resultant mixture was subjected to vacuum desiccation during heating.

In a dry room, 0.100 g of C₆₀ (0.139 mmol), 0.0399 g of LiTFSI (0.139 mmol), and 0.0738 g of N,N′-ethylmethylimidazole TFSI salt ([CH₃CH2(C₃H₃N₂)CH₃]+[(CF₃SO₂)₂N]⁻, EMITFSI, 0.189 mmol) were mixed in a mortar for about 40 minutes. (Molar Ratio: C₆₀:LiTFSI:EMITFSI=1.00:1.00:1.36) On starting the mixture, the mixture changed to gelatinous. However, the gelatinous mixture had a little lower viscosity than the black gelatinous mixture obtained in Example 3. This sample (gel) was subjected to vacuum desiccation at 100° C. followed by performing impedance measurement and TGDTA measurement.

As shown in (c) of FIG. 4, the ionic conductivity of the gelatinous dry mixture obtained in Example 5 was approximate 10-times greater than that in Example 3 (see (a) of FIG. 4), and for example, ionic conductivity at 20° C. was 2.2×10⁻³ S/cm. The reference value of the ionic conductivity of EMITFSI at 25° C. is reported to be 8.4×10⁻² S/cm. The ionic conductivity shown in (c) of FIG. 4 was recognized to be high despite the result that the ionic conductivity was a little lower than this reference value. Further, the ionic conductivity shown in (c) of FIG. 4 was recognized to be higher than that in the electrolyte containing a polymeric matrix even at a low temperature range.

As discussed above, it was confirmed that the gelatinous substance was obtained even if the ionic liquid was used, and further the gelatinous substance had higher ionic conductivity.

In the above Examples, LiTFSI as an example of an electrolyte salt, acetone, which is an organic solvent, as a liquid compound having polarity and allowing ionic dissociation of an electrolyte salt, and EMITFSI as an example of an ionic liquid are included and discussed, but it is needless to say that other electrolytes, organic solvents or ionic liquids may be used.

For example, as an electrolyte, in addition to LiTFSI (C₂F₆LiNO₄S₂, lithium bis(trifluoromethanesulfone imide), Bis(trifluoromethylsulfonyl)litiomethane (C₃HF₆LiO₄S₂), [Tris[(trifluoromethyl)sulfonyl]methyl]lithium (C₄F₉LiO₆S₃), trifluoromethanesulfonic acid lithium salt (CF₃LiO₃S), Nonafluoro-1-butanesulfonic acid lithium salt (C₄F₉LiO₃S) and the like may be used.

For example, as a polar organic solvent, in addition to acetone, formic acid (HC(═OOH), acetic acid (CH₃C(═O)OH)), ethyl methyl ketone (CH₃C(═O)CH₂CH₃), diethyl ketone (CH₃CH₂C(═O)CH₂CH₃), dimethyl ether (CH₃—O—CH₃), diethyl ether (CH₃CH₂—O—CH₂CH₃), methyl acetate (CH₃C(═O)OCH₃), ethyl acetate (CH₃C(═O)OCH₂CH₃)), N,N-dimethylformamide (DMF, HC(═O)N(CH₃)₂, and tetrahydrofuran (THF) may be used.

For example, as an ionic liquid, in addition to EMITFSI, 1-alkyl-3-methyl imidazolium salt may be used. When this salt is represented as [1—R-3-methyl imidazolium]⁺[X]⁻ where R is alkyl group and X is an atom forming anion or atom group thereof, for example, R may be ethyl group, hexyl group, octyl group, decyl group, dodecyl group, tetradecyl group, hexadecyl group, octadecyl group and the like, and X such as Br, Cl, PF₆, BF₄, (CF₃SO₂)₂N, CF₃SO₃, CH₃CH(OH)COO, and the like may be used.

Further, 1-alkyl-2,3 dimethyl imidazolium salt may be used. When this salt is represented as [1—R-2,3-methyl imidazolium]⁺[X]⁻ where R is alkyl group and X is an atom forming anion or atom group thereof, for example, R may be ethyl group, butyl group, hexyl group and the like, and X such as Br, Cl, BF₄, (CF₃SO₂)₂N, and the like may be used.

Furthermore, N,N,N-Trimethyl-N-propylammoniumbis(trifluoromethanesulfonyl)imide, N-Diethyl-N-methyl-N-(2-methoxyethyl)ammoniumbis(trifluoromethanesulfonyl)imide, N-Diethyl-N-methyl-N-(2-methoxyethyl)ammonium tetrafluorobborate, N-Methyl-N-propylpiperidiumbis(trifluoromethanesulfonyl)imide, N-Methyl-N-propylpyrrolidium bis(trifluoromethanesulfonyl)imide, N-Methyl-N-butylpyrrolidium bis(trifluoromethanesulfonyl)imide and the like may be used.

As discussed above, the present invention has been discussed with reference to embodiments and Examples. However, the present invention is not limited to aspects discussed in the above embodiments and examples, and various modifications based on technical ideas of the present invention are available.

For example, in example 5 when an ionic liquid is solid at room temperature, the electrolyte may be prepared by dissolving this ionic liquid in polar solvents such as acetone to be used followed by the above wet mixing method.

Further, in Example 3, the electrolyte may be prepared by dissolving the ionic liquid in polar solvents such as acetone followed by the above wet mixing method.

Furthermore, the electrolyte according to the present invention may be applied to not only batteries but also other electrochemical devices except batteries. Examples of other application include a capacitor and the like.

Further, in the above embodiment, the lithium ion secondary battery in which the capacity of an anode represents a capacity component based on insertion and extraction of lithium is discussed as a battery according to the present invention. However, it is not limited to this. The battery according to the present invention may be similarly applied to a lithium metal secondary battery in which the capacity of an anode represents a capacity component based on precipitation and dissolution of lithium; and a secondary battery in which the charging capacity of anode material capable of inserting and extracting lithium is made smaller than that of cathode and thereby the anode capacity includes the capacity based on insertion and extraction of lithium and the capacity based on precipitation and dissolution of lithium and represents a total capacity of these capacities.

Further, in the above embodiment, the battery of the present invention is discussed with an example in a case using lithium as an electrode reactant. However, other Group 1 elements such as sodium (Na) and potassium (K) in the long period periodic table, Group 2 elements such as magnesium and calcium (Ca) in the long period periodic table, or other light metals such as aluminum may be used. In this case, the anode material discussed in the above embodiment may be used as an anode active material as well.

Further, in the above embodiment, the battery of the present invention is discussed with an example in a coin type battery as a battery structure. However, the battery of the present invention may be similarly applied to batteries having other battery structures such as a cylindrical battery, a laminated film battery, a square battery, and a button battery or a battery in which the battery element has a laminated structure, a spirally wound structure or the like. Further, the battery of the present invention is not limited to the secondary battery, but may be similarly applied to other types of battery such as a primary battery.

### INDUSTRIAL APPLICABILITY

The present invention may be appropriately applied to electrochemical devices such as a Li battery based on electrochemical reaction.

1-17. (canceled)

18. An electrolyte formed from a liquid mixture, the liquid mixture comprising:
an electrolyte salt containing at least one kind of an alkali metal salt and an alkali-earth metal salt;
a carbon cluster; and
a liquid compound having polarity and dissociating the electrolyte salt into ions.

19. The electrolyte of claim 18, wherein the liquid compound is an organic solvent containing any one of ether group, ester group, and carbonyl group.

20. The electrolyte of claim 18, wherein the liquid compound is an ionic liquid.

21. The electrolyte of claim 18, wherein when each molar ratio of the electrolyte salt, the carbon cluster, and the liquid compound included in the liquid mixture is represented by MS, MC, and ML, the relationship is ML≧MS≧MC.

22. The electrolyte of claims 18, wherein the electrolyte salt or the liquid compound has a polymerizable functional group, and the polymerizable functional group is polymerized and thereby the liquid mixture is pectized.

23. The electrolyte of claim 18, wherein the carbon cluster is at least one kind among the group consisting of fullerene, carbon nanotube, graphene, a hydride of fullerene, a hydride of carbon nanotube, a hydride of graphene, an oxide of fullerene, an oxide of carbon nanotube, an oxide of graphene, and defectives thereof.

24. The electrolyte of claim 18, wherein the alkali metal salt is at least one kind of a lithium salt, a sodium salt, and a potassium salt.

25. A battery comprising:
an electrolyte;
a cathode; and
an anode, wherein the electrolyte is formed from a liquid mixture including:
(a) an electrolyte salt containing at least one kind of an alkali metal salt and an alkali-earth metal salt;
(b) a carbon cluster; and
(c) a liquid compound having polarity and dissociating the electrolyte salt into ions.

26. A method of using a battery comprising an electrolyte, a cathode and an anode, wherein the electrolyte is formed from a liquid mixture including:
(a) an electrolyte salt containing at least one kind of an alkali metal salt and an alkali-earth metal salt;
(b) a carbon cluster; and
(c) a liquid compound having polarity and dissociating the electrolyte salt into ions, and, wherein the battery is used at a temperature of 100° C. or below.

27. A method for producing an electrolyte, comprising:
(a) preparing a liquid mixture by addition of an electrolyte salt containing at least one kind of an alkali metal salt and an alkali-earth metal salt and a carbon cluster to a liquid compound having polarity and dissociating the electrolyte salt into ions; and
(b) desiccating the liquid mixture by vacuum heating.

28. The method of claim 27, wherein the liquid compound is an organic solvent containing any one of ether group, ester group, and carbonyl group.

29. The method of claim 27, wherein the liquid compound is an ionic liquid.

30. The method of claim 27, wherein when each molar ratio of the electrolyte salt, the carbon cluster, and the liquid compound included in the liquid mixture is represented by MS, MC, and ML, the relationship is ML≧MS≧MC.

31. The method of claims 27, wherein:
(a) the electrolyte salt or the liquid compound has a polymerizable functional group; and
(b) the method includes polymerizing the polymerizable functional group, and thereby the liquid mixture is pectized.

32. The method of claim 27, wherein the vacuum desiccation temperature in the second step is at a temperature of 100° C. or below.

33. The method of claim 27, wherein the carbon cluster is at least one kind among the group consisting of fullerene, carbon nanotube, graphene, a hydride of fullerene, a hydride of carbon nanotube, a hydride of graphene, an oxide of fullerene, an oxide of carbon nanotube, an oxide of graphene, and defectives thereof.

34. The method of claim 27, wherein the alkali metal salt is at least one kind of a lithium salt, a sodium salt, and a potassium salt.
